(19) United States
(12) Patent Application Publication
(10) Pub. No.: US 2026/0309903 A1
(43) Pub. Date: Oct. 8, 2026

(54) METHOD AND SYSTEM FOR PRODUCING LIGHT MANIPULATING PATTERN ON A SURFACE

(71) Applicant: BAR ILAN UNIVERSITY, Ramat Gan (IL)

(72) Inventor: Zeev ZALEVSKY, Rosh HaAyin (IL)

(21) Appl. No.: 19/171,520

(22) Filed: Apr. 7, 2025

(51) Int. Cl. G02B 5/18; G02C 7/02; G02C 7/04

(52) U.S. Cl. CPC G02B 5/1866; G02B 5/1842; G02B 5/1876; G02C 7/022; G02C 7/049; G02C 2202/20; G02C 2202/24

(57) ABSTRACT

A method and system are presented for pattern data generation for a pattern to be made on a surface region of an optical element having predetermined focusing property for light of wavelength λ and with respect to a predetermined focal length f. The pattern is formed by a concentric circular arrangement of N periods of binary Damman Gratings, where period of the binary Dammann grating is defined as \sqrt{2λf}, and each period has a central radius rₙ=\sqrt{nλf}, and each binary Dammann grating has a selected arrangement of M transition points optimized such that said focusing property of the pattern induces single-focus f property to the optical element with enhanced energy efficiency or provides extended depth of focus with enhanced energy efficiency around a given focal plane f of the optical element.

### TECHNOLOGICAL FIELD

The present disclosure is in the field of diffraction grating based optical techniques and relates to method and system for use in producing a pattern on a surface.

### BACKGROUND

Binary Fresnel zone plates (FZPs) represent a significant advancement in light manipulation and focusing, using concentric rings to diffract light based on constructive and destructive interference. Generally, a Fresnel zone plate focuses light by utilizing the principle of diffraction and interference, with the concentric rings creating constructive interference at a specific focal point, thereby converging the incident light. FZPs have found applications in X-ray microscopy, astronomy, and photonic integrated circuits due to their ability to focus light without chromatic aberrations and their feasibility for implementing binary and flat optical structures. However, FZPs suffer from efficiency issues due to their diffractive nature, with a significant portion of incident light being lost or scattered.

Dammann gratings typically have arrays of transition points, and are used for splitting an incident beam into multiple output beams with equal intensity.

Techniques utilizing combination of the principles of Dammann gratings with FZPs to produce multiple axial focal points with equal intensity have been developed, and are described for example in the following publications: J. Yu, Changhe Zhou, Wei Jia, et al., “Three-dimensional Dammann array,” Appl. Opt. 51(10), 1619 (2012); C. Zhou, Jun Zhang, Xiaoxin Wang, et al., “Three-dimensional optical techniques using Dammann gratings,” in Holography, Diffractive Optics, and Applications V, SPIE publication (2012).

### GENERAL DESCRIPTION

There is a need in the art to produce/design a pattern on a surface such that the pattern is capable of affecting the focusing properties of light incident thereon with high efficiency and precision.

The present disclosure provides a novel approach for determining pattern data (pattern features) for creation of the pattern on a surface. In some applications, the pattern to be created on the surface is aimed at focusing incident light on a single focal point. In some other applications, the pattern to be designed is to be created on a surface of an element having a focal length, in which case the pattern is configured to provide extended depth of focus around the focal length of said element.

For example, the element with focal length may be a lens, e.g., contact lens, ophthalmic lens, on the surface of which the pattern is to be created.

In another example, the optical element may be constituted by a surface of cornea, i.e., the cornea together with an eye lens present such an optical element. The technique of the present disclosure can advantageously be used for astigmatism correction and/or correction of refractive error of user's eye caused by myopia or presbyopia progression.

In the description below, the pattern that is to be designed is at times referred to as a “light focusing pattern”, although in some aspects/embodiments the pattern is not “focusing” but affecting focusing properties of light, namely is designed for/aimed at providing an extended depth of focus.

Generally, the pattern generated by the technique of the present disclosure presents an optimized pattern being a binary amplitude modulation pattern along a radial direction which is optimized such that, when the pattern is applied to/made on a surface of an element, it either creates or modifies the focusing property of the element. Creation of the focusing property is aimed at providing light focusing on a single point at a certain distance from the surface. Modification of the optical property is aimed at adding extended depth of focus property to a certain focal length of an element (e.g., lens or lensing unit formed by cornea with eye lens) on the surface of which the pattern is made.

It should be understood that binary arrangement of transition points may generally include two values of different transparency. In the examples presented below, such binary arrangement is assumed to be formed by an alternating arrangement of transparent and opaque regions, since this is suitable for ophthalmic applications.

In the description below, the surface with the light focusing pattern designed according to the principles of the present disclosure is termed Circular Dammann Fresnel Zone Plate (CDFZP) or “hybrid grating”. It should, however, be understood that such CDFZP pattern has actually no Fresnel Zones as such but rather presents a novel (optimized) arrangement of Dammann Gratings. More specifically, the CDFZP does not include Fresnel zone plates as separate components, but rather, it represents a light transmitting pattern that incorporates design principles from both Dammann gratings and Fresnel zone plates into a single, unified patterned structure. The CDFZP has concentric rings similar to traditional Fresnel zone plates, but with critically different arrangement of Dammann grating transition points whose number and position are determined through the optimization process of the present disclosure.

It should be noted that the CDFZP pattern configured to focus light on a single focal point has optical power, although a binary Dammann grating as such has no optical power. The optical power is induced in the CDFZP pattern due to the combination of the principles (transmission properties) of binary Fresnel zone plate and Dammann gratings.

As for the CDFZP pattern configured to add the property of extension of depth of focus to a lens or lens unit (as described above), such pattern itself has no optical power in the traditional sense and presents the optimized configuration of a binary Dammann grating, where the optimization utilizes transmission properties of a Fresnel zone plate.

More specifically, the extended depth of focus is obtained by manipulating the transition points of a binary Dammann grating such that a tunable, small number of focusing points are controllably “defocused” to provide extension of depth of focus around an existing focal point. The incident light is spread across multiple interference patterns, preventing rapid intensity decay when moving away from the best-focus plane (focal plane of the optical element). The binary Dammann grating pattern of the present disclosure presents alternating transparent and opaque regions to the incident light. The pattern formed on the surface is designed to shape the point spread function (PSF) in a way that increases the range over which the image remains sharp (i.e., the depth of focus is extended). It should be noted that the approach used in the technique of the present disclosure is based on the optimized arrangement of the transition positions of the binary Dammann gratings that provides the required degree of freedom for parameter space to obtain extended depth of focus (which is different from the continuous parameter space in the phase-based approach).

Additionally, the binary Dammann grating pattern of the present disclosure acts as the binary amplitude mask whose operation is not dependent/not affected by wavelength phase effects. This allows use of the pattern designed by the technique present disclosure in various broadband applications, e.g., ophthalmic applications.

As will be described more specifically further below, the configuration of the Dammann Gratings forming the light focusing pattern of the present disclosure utilizes transmission properties of binary Fresnel Zones, in particular the functionality of a Fresnel zone plate is considered to define the locations of successive Dammann grating periods. The light focusing pattern of the present disclosure is designed such that each zone of a binary Fresnel zone plate is replaced by a binary pattern of a single period of the Dammann grating. In other words, the resulting light focusing pattern cannot be considered as a Fresnel zone plate, since there are no Fresnel zones as such.

According to one aspect of the present disclosure, the light focusing pattern, implementing the CDFZP technique of the present disclosure, is configured to concentrate most of the incoming light into a single point instead of spreading it evenly across many points for which known Damman gratings are typically designed. The CDFZP-based light focusing pattern is designed to align the uniform light distribution capabilities of Dammann gratings with the focusing geometry of binary Fresnel zone plates. The design manipulates the Dammann grating patterns to ensure that light is efficiently focused in the desired focus position and to avoid focusing in the undesired diffraction orders of the regular binary FZP element.

In another aspect of the present disclosure, the CDFZP pattern is designed such that an extended depth of focus with higher energetic efficiency is achieved around the focal plane of a lens (or lens unit) on top of which the patterned structure is positioned.

Thus, according to one broad aspect of the present disclosure, it provides a method for use in producing a pattern on a surface of an element within a surface region of a certain diameter to create a patterned region with predetermined focusing property, the method comprising:
utilizing transmission property of a binary arrangement of N Fresnel Zones along the patterned region of the certain diameter for a predetermined wavelength λ and a predetermined focal length f, where each n-th Fresnel zone has a central radius rₙ=\sqrt{nλf}, n=1, . . . , N, and determining a period P of a binary Dammann grating as \sqrt{2λf} and position data of the number N of periods of the binary Dammann gratings such that each n-th period of the binary Dammann grating has the central radius rₙ=\sqrt{nλf};
utilizing data indicative of the period P of the binary Dammann grating and said position data and determining an optimized arrangement of a selected number M of transition points, x₁, . . . , x_{M}, along a radial dimension of each period of the binary Dammann grating such that the optimized arrangement of the transition points provides said predetermined focusing property of the pattern with enhanced energy efficiency as compared to an energy efficiency of the binary arrangement of the N Fresnel zones; and
generating pattern data indicative of the pattern comprising the optimized arrangement of the M transition points for each of said N periods of the binary Damman gratings.

In some embodiments, said predetermined focusing property corresponds to the predetermined focal length f to be provided by the pattern created on said surface region.

In some embodiments, said element is an optical element, said predetermined focal length f corresponds to a focal plane of the optical element, said predetermined focusing property characterizing an extended depth of focus around said focal plane being provided by the pattern created in said surface region.

In some embodiments, the optical element is being one of the following: a lens, an ophthalmic lens, a contact lens, a lens unit formed by a surface of cornea and eye lens.

In some embodiments, the optimized arrangement of the selected number M of the transition points, x₁, . . . , x_{M}, is determined to satisfy a condition for a maximal value of parameter ηₘₐₓ defined as a product η₁η₂, where parameter η₁ represents energy of a first diffraction order relative to the other diffraction orders in light interacting with the binary Damman gratings having said optimized arrangement of the M transition points, and parameter η₂ represents energetic efficiency of the binary Damman gratings having said optimized arrangement of the M transition points and is indicative of how effectively it manipulates the light interacting with said binary Damman gratings to achieve said predetermined focusing property.

The parameter η₁ can be defined by Fourier coefficients, Aₙ, of a periodic square wave transmission profile t(r²) as

$${A}_{1}^{2} / {\sum }_{n = 0}^{N} {A}_{n}^{2} ,$$

and the parameter η₂ can be defined by a first Fourier coefficient A₁ of the periodic square wave transmission profile t of the binary Fresnel Zones as

$${A}_{1}^{2} / {\int }_{0}^{1} t ( x ) dx ,$$

where integration is performed over a single Dammann grating period P.

In some embodiments, the determination of the optimized arrangement comprises iteratively performing the following:
for each set of coordinates of the M transition points, x₁, . . . , x_{M}, calculating corresponding values of the Fourier coefficients Aₙ, and calculating a value of the parameter η; and
identifying the set of the coordinates of the transition points that yields the maximal value of the parameter η.

In some embodiments, the method further comprises: utilizing said pattern data to operate a patterning system to create said pattern on the surface region of said surface.

In some embodiments, the surface is a surface of an eye cornea associated with an eye lens having said predetermined focal length f, said focusing property of the pattern characterizing an extended depth of focus around a focal plane of the eye lens.

In some other embodiments, the surface is an optical element (e.g., mask) having said predetermined focal length f, said focusing property of the pattern characterizing an extended depth of focus around a focal plane of the optical element. In some embodiments, the optical element is a lens, e.g., contact lens or ophthalmic lens.

In some embodiments, the optimized pattern is configured for correcting refractive error of user's eye caused by myopia or presbyopia progression.

According to another broad aspect of the present disclosure, it provides an optical element having a surface comprising a pattern within a patterned region of said surface, said pattern being characterized by a predetermined focusing property with respect to incident light of wavelength λ and with respect to a predetermined focal length f, the pattern being formed by a concentric circular arrangement of N periods of binary Damman Gratings, wherein a period P of the binary Dammann grating is defined \sqrt{2λf}, each n-th period of the binary Dammann gratings has a central radius rₙ=\sqrt{nλf}, and each binary Dammann grating comprises a selected arrangement of M transition points, said selected arrangement of M transition points being optimized such that said focusing property of the pattern provides one of the following: (i) inducing focusing functionality to the optical element providing said predetermined focal length f with enhanced energy efficiency as compared to an energy efficiency of an arrangement of N binary Fresnel zones each having said central radius rₙ=\sqrt{nλf}, or (ii) provides an extended depth of focus with enhanced energy efficiency around a given focal plane of said optical element having said predetermined focal length f.

According to yet further broad aspect of the present disclosure, it provides a system for use in producing a pattern with a predetermined focusing property to be formed within a surface region of a certain diameter of an optical element. The system is configured as a computerized system comprising data input and output utilities, memory utility and a data processor system, the data processor system comprising:
an analyzer configured and operable to utilize transmission property of a binary arrangement of N Fresnel zones along said patterned region of the certain diameter for a predetermined wavelength λ and a predetermined focal length f, where each n-th Fresnel zone has a central radius rₙ=\sqrt{nλf}, n=1, . . . , N, and determining a period of a binary Dammann grating as \sqrt{2λf} and position data of the number N of periods of the binary Dammann gratings such that each n-th period of the binary Dammann grating has the central radius rₙ=\sqrt{nλf};
a Dammann grating optimizer configured and operable to utilize data indicative of the period of the binary Dammann grating and said position data and determine an optimized arrangement of a selected number M of transition points, x₁, . . . , x_{M}, along a radial dimension of each period of the binary Dammann grating such that said optimized arrangement of the transition points provides said predetermined focusing property of the pattern providing one of the following: (i) inducing focusing functionality in the optical element providing the focal length f of the pattern with enhanced energy efficiency as compared to an energy efficiency of the binary arrangement of the N Fresnel zones; or (ii) providing an extended depth of focus with enhanced energy efficiency around a focal plane of an optical element with said predetermined focal length f having said patterned region; and
a pattern data generator configured and operable to generate pattern data indicative of the pattern comprising the optimized arrangement of the M transition points for each of said N periods of the binary Damman gratings.

### BRIEF DESCRIPTION OF THE DRAWINGS

The patent or application file contains at least one drawing executed in color. Copies of this patent or patent application publication with color drawing(s) will be provided by the Office upon request and payment of the necessary fee.

In order to better understand the subject matter that is disclosed herein and to exemplify how it may be carried out in practice, embodiments will now be described, by way of non-limiting examples only, with reference to the accompanying drawings, in which:

FIG. 1A shows schematically a system according to the principles of the present disclosure for use in producing a light focusing pattern within a patterned region of a surface;

FIG. 1B exemplifies, by way of a flow diagram, a method of the present disclosure for generation of light focusing pattern data to produce the pattern on a surface within a patterned region of a given diameter;

FIG. 2 shows a schematic representation of the simulated/computed light focusing pattern configured based on CDFZP approach of the present disclosure with superior focusing ability, the diameter of the CDFZP is 1.6 mm;

FIG. 3A shows 1D phase distribution of a Dammann grating;

FIG. 3B shows transmission cross section of an amplitude binary Fresnel zone plate as a function of its radius square;

FIG. 4 exemplifies, by way of a flow diagram, a method of the present disclosure to optimize the transition points of the CDFZP grating;

FIG. 5 shows a single period of the optimized CDFZP grating plotting it transmission versus r² where r is the radial coordinate;

FIGS. 6A and 6B show the focusing properties through the CDFZP, where

FIG. 6A shows the optical rays' paths, and FIG. 6B shows the intensity of the outbound 532 nm light, the simulated lens has a focal length of 3 cm and a diameter of 1.6 mm;

FIGS. 7A to 7C show the imaging capabilities of the CDFZP compared to a traditional lens, where FIG. 7A shows a reference image, FIG. 7B shows imaging through a traditional lens, and FIG. 7C shows imaging through a CDFZP;

FIG. 8 shows through focus modulation transfer function (MTF) chart for the conventional lens (blue) and CDFZP (orange), since the conventional lens is mono-focal, its through focus MTF is zero everywhere except in the proximity of z=3 cm (the focal length of the lens);

FIGS. 9A and 9B illustrate the beam propagation profile along the z-axis, offering a clear view of the beam's trajectory in free space, showing beam intensity along y-axis (FIG. 9A) and x-axis (FIG. 9B);

FIGS. 10A and 10B show the laser beam without the mask (FIG. 10A) and with the mask at the focal point (FIG. 10B); and

FIG. 11A to 11D show a detailed examination of the beam's focal spot along y (FIG. 11A) and x (FIG. 11C) axes, indicated by a red dashed line, FIGS. 11B and 11D display the intensity profile along y (FIG. 11B) and x (FIG. 11D) axes with the red line denoting the full width at half maximum (FWHM) of the spot, the FWHM values of 18.43 μm and 19.15 μm along the y and x axes, respectively;

FIG. 12A shows a flow diagram of a method of the present disclosure to create a pattern on a surface region (of a certain diameter) of an optical element (with no pattern) having certain focal plane, and the pattern region provides an extended depth of focus around the focal plane of the optical element;

FIG. 12B shows an exemplary simulation of a CDFZP designed using the method of FIG. 12A being realized on a surface of a human eye model with an entrance pupil diameter (EPD) of 3.5 mm;

FIGS. 13A to 13F show the calculated Modulation Transfer Function (MTF) plotted as a function of focus shift, wherein FIGS. 13A and 13B show MTF performance for EPD of 2.5 mm at 50 cycles/mm (FIG. 13A) and 100 cycles/mm (FIG. 13B); FIGS. 13C and 13D show MTF performance for EPD of 3 mm at 50 cycles/mm (FIG. 13C) and 100 cycles/mm (FIG. 13D); and FIGS. 13E and 13F show MTF performance for EPD of 3.5 mm at 50 cycles/mm (FIG. 13E) and 100 cycles/mm (FIG. 13F);

FIG. 14 shows a homogenously illuminated reference human eye model with EPD of 2 mm; and

FIGS. 15A and 15B show, respectively, the MTF performance at 50 cycles/mm and 100 cycles/mm.

### DETAILED DESCRIPTION OF EMBODIMENTS

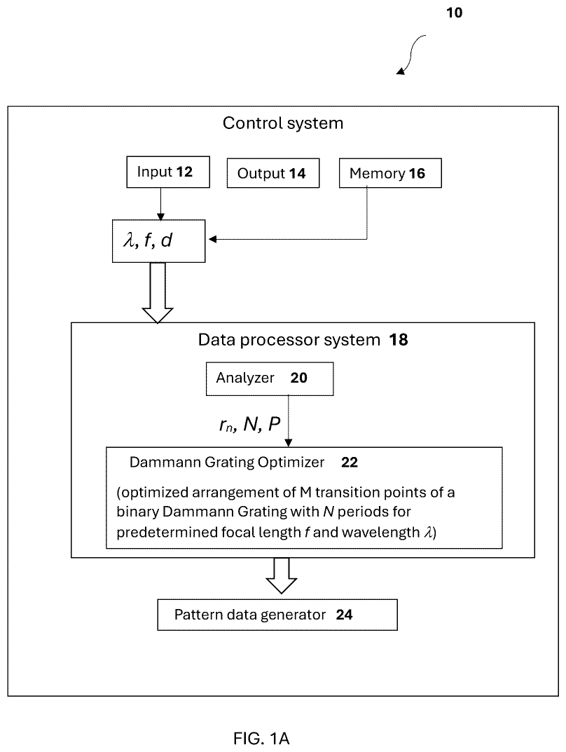

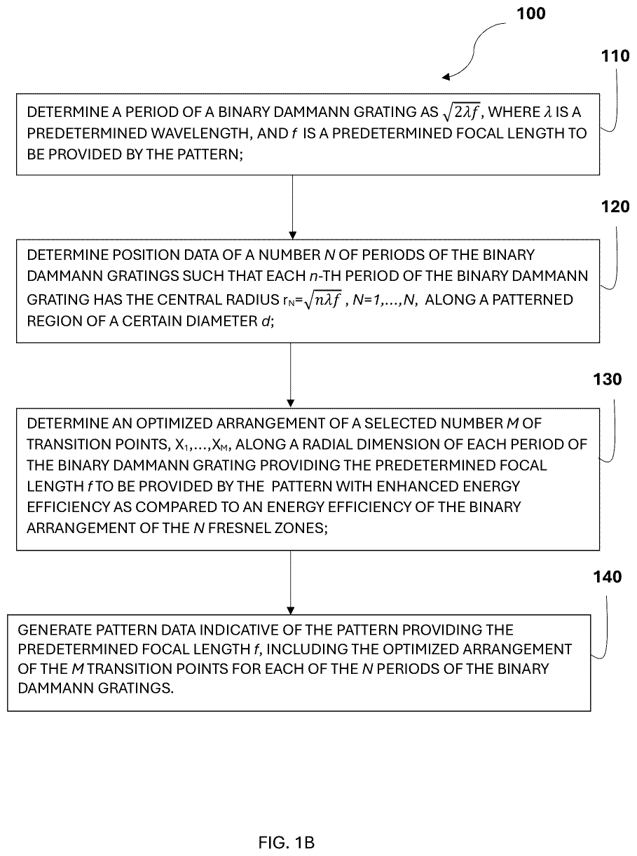

Reference is made to FIGS. 1A and 1B showing schematically a system 10 (FIG. 1A) and a flow diagram 100 of method (FIG. 1B) of the present disclosure for use in producing a pattern on a surface of an element within a surface region of a certain diameter d to create a patterned region with predetermined focusing property.

As will be described further below, in some embodiments, the pattern is designed to induce/create a single-point focusing property in/to said element, which otherwise (with no pattern) might have no optical power/focusing functionality at all. In some other embodiments, the element is an optical element having certain focusing properties, and the pattern to be made on the surface of such element is designed to modify said focusing properties.

The system 10 is configured as a computerized system comprising inter alia data input utility 12, data output utility 14, memory utility 16, and a data processor system 18. The data processor system 18 includes an analyzer 20, a Dammann Grating optimizer 22, and a pattern data generator 24.

As mentioned above, the technique of the present disclosure is aimed at designing a pattern to be produced within a given patterned region (of a given size/diameter d) on a surface, such that, in some embodiments, the pattern is capable to effectively and uniformly focus incident light of a certain wavelength k on a desired focal point. In other embodiments, the pattern can be configured to provide extended depth of focus around a focal point of an optical element having the surface on which the pattern is to be created. Thus, the light focusing pattern (in a broad sense, i.e., either focusing or extending an existing focus) is configured for desired wavelength k and desired focal length f, as well as a desired size (diameter d) of the surface region to be patterned with such pattern. As also mentioned above, the present disclosure provides for designing the pattern formed by optimized concentric circular arrangement of binary Dammann gratings.

The analyzer 20 is configured and operable to determine a period of the binary Dammann grating and position data of the arrangement of the binary Dammann gratings. To this end, according to the present disclosure, the analyzer 20 utilizes data indicative of a transmission property of a binary arrangement of N Fresnel Zones, if such would be formed along the patterned region of the certain diameter d for the predetermined wavelength λ and the predetermined focal length f of the light focusing pattern. The number N of Fresnel Zones is actually defined inter alia by the size d of the region to be patterned (e.g., the maximal rₙ should match d). Each n-th Fresnel zone in such configuration has a central radius rₙ=\sqrt{nλf}, n=1, . . . , N.

The transmission property, T(rₙ), of the binary arrangement of N Fresnel Zones is used to determine the period P of the binary Dammann grating, having the central radius rₙ=\sqrt{nλf}, as P=\sqrt{2λf}, and to determine the position data of the number N of such periods of the binary Dammann gratings. As described more specifically further below, the transmission property of the arrangement of binary Fresnel zones is defined by transmission cross section of an amplitude binary Fresnel zone plate, which is periodic with the square of the zone radius

$${r}_{n}^{2} ,$$

with a period of 2λf.

Thus, as shown in FIG. 1B, in the first step (step 110) of flow diagram 100, the period of the binary Dammann grating is determined as \sqrt{2λf} based on the transmission property of the binary arrangement of N Fresnel Zones, where λ is the predetermined wavelength and f is the predetermined focal length to be provided by the pattern. In step 120, the position data of the number N of periods of the binary Dammann gratings along the region of the diameter d is determined to satisfy the condition that each n-th period of the binary Dammann grating has the central radius rₙ=\sqrt{nλf}, n=1, . . . , N.

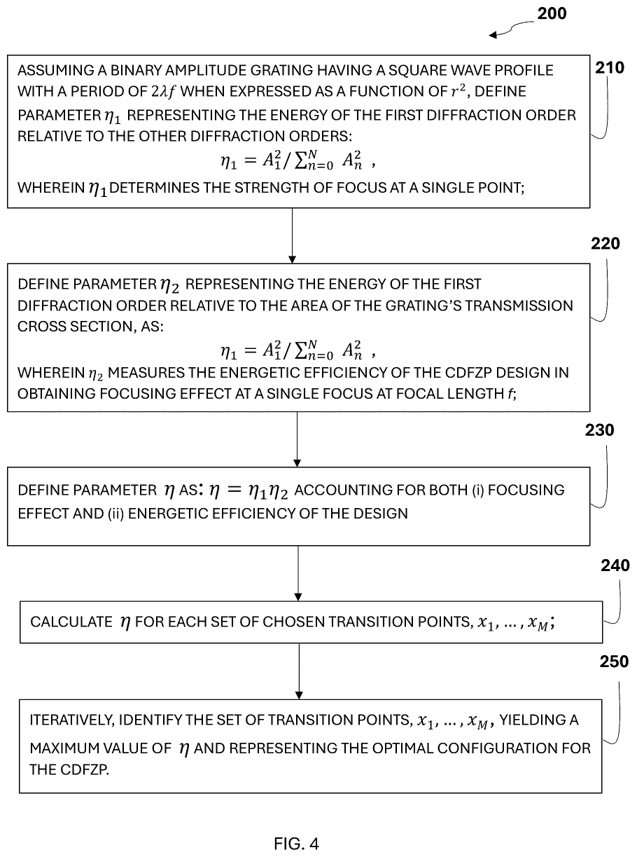

The Dammann grating optimizer 22 operates to utilize the data indicative of the period P of the binary Dammann grating and the position data of the N periods of the binary Dammann gratings along the region of the diameter d, to determine an optimized arrangement of a selected number M of transition points, x₁, . . . , x_{M}, along a radial dimension of each period P of the binary Dammann grating (step 130). In the exemplary embodiment of FIG. 1B, the optimized arrangement of the M transition points is configured to provide the predetermined focal length f of the light focusing pattern with enhanced energy efficiency as compared to an energy efficiency of the binary arrangement of the N Fresnel zones. The technique of the present disclosure to determine the optimized arrangement of the selected number M of transition points, x₁, . . . , x_{M}, along the radial dimension of each period P of the binary Dammann grating is described more specifically further below, with reference to FIG. 4.

Then, the optimizer 22, or a separate pattern data generator 24 as the case may be, generates pattern data (step 140). The pattern data is indicative of the arrangement of N periods of the binary Damman gratings with the optimized arrangement of the M transition points in each period P. In the exemplary embodiment of FIG. 1B, the pattern provides the predetermined focal length f.

According to the principles of the present disclosure, the above-described novel approach for designing a pattern on a surface is used, which is termed here as Circular Dammann Fresnel Zone Plate (CDFZP) approach. This approach requires combining the principles/functionalities of two key technologies: binary Dammann gratings and binary Fresnel zones while implementing/configuring the arrangement of binary Dammann gratings for focusing most of the incoming light into limited number of focal points (instead of spreading it evenly across many points), e.g. only in −1, 0 and 1 diffraction orders

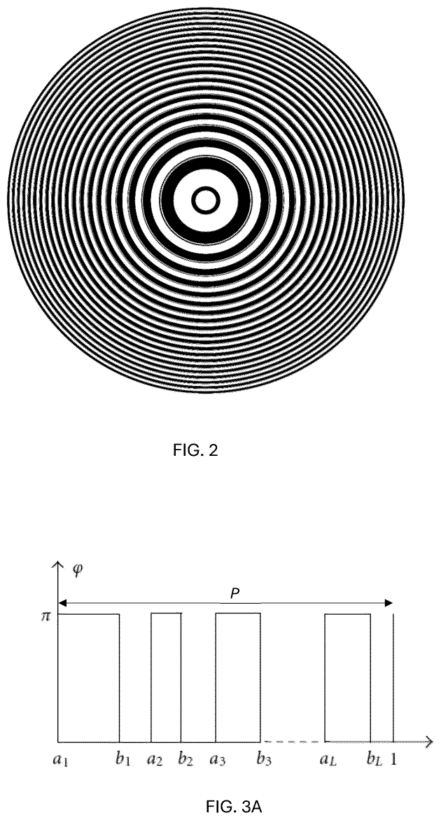

FIG. 2 exemplifies a schematic representation of the simulated/computed pattern configured based on the CDFZP approach of the present disclosure with superior focusing ability. In this example, the diameter d of the CDFZP patterned region is 1.6 mm.

It should be understood that conventional approach for designing and using Dammann gratings is based on that Dammann gratings are specialized optical tools designed for evenly splitting light into multiple beams. These gratings work on the far-field diffraction principle, meaning they manipulate light at a distance, and are used in technologies like optical fiber communications, laser pulse shaping, and creating three-dimensional light arrays. Essentially, these gratings are phase-only modulators optimized for equal-intensity spot generation at different diffraction orders.

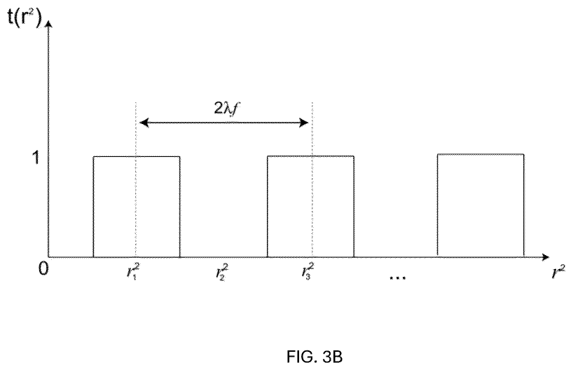

A Dammann grating is considered with the phase value of 0 or π and a period P, as shown in FIG. 3A. The coordinates of the phase jump points of the 1D grating in each period are aₗ, bₗ(l=1, 2, . . . L), where L is the number of phase jump points in the positive region of x₀ (the structure is symmetric around x₀=0). The corresponding transmittance function is written as [X. Ji, S. Xu, and S. Gu, “Generation of Atomic Optical Lattices by Dammann Gratings,” Adv. Opt. Technol. 2012, 1-9 (2012)].

$$g ( {x}_{0} ) = {\sum }_{l = 1}^{L} [ rect ( \frac{{x}_{0} - ( {b}_{l} + {a}_{l} )}{2 ( {b}_{l} - {a}_{l} )} ) - rect ( \frac{{x}_{0} - ( {a}_{l + 1} + {b}_{l} )}{2 ( {a}_{l + 1} - {b}_{l} )} ) ] \qquad ( 1 )$$

where rect(⋅) is the rectangular function.

The period of the grating is normalized to the value of “1”. Among different roles, the Dammann grating can also serve as a binary amplitude grating, exhibiting a similar structure as in other use-cases, but with transmission values of “0” and “1”.

Binary Fresnel zone plates are specialized lenses designed to focus light. They consist of many closely spaced rings, called zones, and are effective in concentrating light into specific points along their main axis. While these lenses can create multiple focal points, the light's intensity often varies between these points, especially at higher orders.

If a small Fresnel zone plate compared to the focal length is considered, the central radius of every ring can be approximated as

$${r}_{n}^{2} = n λ f \qquad ( 2 )$$

where n is the number of the ring having radius of rₙ and f is the focal length of the zone plate, and A is the optical wavelength.

Following this, a binary amplitude grating can be regarded as a square wave profile with a period of 2λf when expressed as a function of r², where r is the radius. FIG. 3B shows the transmission cross section of an amplitude binary Fresnel zone plate as a function of its radius square, t(r²).

Thus, due to the periodicity of t(r²), it can be expressed using Fourier series (t(r²) is a continuous and a periodic function and thus it can be developed to Fourier series):

$$t ( {r}^{2} ) = {\sum }_{n = - ∞}^{∞} {A}_{n} exp ( \frac{2 π {inr}^{2}}{2 λ f} ) = {\sum }_{n = - ∞}^{∞} {A}_{n} exp ( \frac{π {inr}^{2}}{λ f} ) \qquad ( 3 )$$

and the Fourier coefficients are:

$${A}_{n} = \frac{1}{2 λ f} {\int }_{0}^{2 λf} t ( x ) exp ( \frac{- π inx}{λ f} ) dx \qquad ( 4 )$$

If a single period of t(r²) is rectangular, as depicted in FIG. 3B, then the Fourier coefficients Aₙ can be expressed as:

$${A}_{n} = \frac{sin ( π n / 2 )}{π n} \qquad ( 5 )$$

The above is equivalent to the existence of many orders, each having a different focal length.

As seen in Eq. (3), it represents a summation of many terms, each being the equation of a lens with focal length of f/n. The energy of the terms reduces with n² since the energy corresponds to Aₙ² (see Eq. (5)). For instance, one may have orders of
. . . −5, −3, −1, 0, 1, 3, 5 . . . with focal lengths of f/n where n is the order number.
   The focal length of the zero order is an infinite focal length (no focusing).

Since the transmission is periodic versus the radius square (Eq. (3)), the inventor has found that it is possible to design this periodic structure as a Dammann grating. The implementation of the Dammann grating based configuration of the pattern according to the present disclosure is aimed at obtaining energetically uniform Fourier coefficients Aₙ and a lesser number of non zero coefficients, e.g. having only −1, 0, 1 orders (less than that is not possible for real and positive values for Aₙ).

It is assumed that in the design problem of a so-called “hybrid optical element” of the present disclosure only real and binary 0.1 values are possible for Aₙ in order to produce the pattern suitable also for use in ophthalmic applications, where due to phase instability in the fabrication process (many times ablation related) only positive binary values are desired for the fabricated structure (CDFZP).

In the following, embodiments of light focusing pattern creation are more specifically described, in which the pattern created on a surface region of an element is aimed at providing light focusing on a single point at a certain distance from the surface. In other words, the circular configuration of CDFZP according to the principles of the disclosure, integrates the principles of both Dammann gratings and binary Fresnel zone plates and is aimed at concentrating the majority of incident light into a single, highly defined focal point. The challenge lies in aligning the uniform light distribution capabilities of the Dammann gratings with the focusing geometry of the binary Fresnel zone plate. Theoretically, this involves manipulating the Dammann grating patterns to work cohesively with the concentric ring structure of the binary Fresnel zone plates. This integration is aimed at manipulating the Dammann grating patterns with the binary Fresnel zones to ensure that light is efficiently focused. This can be done by designing the transition points of the Dammann grating so that light beams from the multiple diffraction orders of the Dammann grating constructively interfere at the focal point of the binary Fresnel zone plate. This involves adjustment of the Dammann grating period and the design of the Dammann grating (arrangement of transition points) to ensure that the majority of the light beams converge at the focal point of the binary Fresnel zone plate.

To implement the above, the light focusing pattern is to be configured for the wavelength of interest, as the focal properties are wavelength dependent. In the experiments conducted by the inventor, wavelength λ=532 nm was chosen, which is a wavelength of interest in diverse applications relevant for FZPs [V. V. Kotlyar, S. S. Stafeev, A. G. Nalimov, et al., “Tight focusing of laser light using a chromium Fresnel zone plate,” Opt. Express 25(17), 19662 (2017); J. Wang, J. Yang, and G. Kang, “Achromatic focusing effect of metasurface-based binary phase Fresnel zone plate,” Phys. Lett. A 407, 127463 (2021)]. Then, the focal length of the CDFZP is chosen to be f=3 cm. Taking these into account, the inventor determined that the period of the square wave profile when expressed as a function of r² is 0.03192 mm².

Reference is made to FIG. 4 exemplifying, by way of a flow diagram 200, a method of the present disclosure to optimize the arrangement of the transition points of the CDFZP grating.

As described above, the optimized light focusing pattern to be designed is aimed at maximizing the light intensity at a single focal point through the precise optimization of the transition points of the Damann grating utilizing transmission property and focusing geometry of a binary Fresnel zone plate.

The configuration of the so-optimized light focusing pattern is to ensure that most of the incident light passes through the pattern and is directed and concentrated at the focal point. According to the present disclosure, in order to achieve this, two key parameters, η₁ and η₂, are introduced, where parameter η₁ represents the energy of the first diffraction order relative to the other diffraction orders in light interacting with the light focusing pattern, and parameter η₂ represents the energetic efficiency of the light focusing pattern and is indicative of how effectively the light focusing pattern manipulates the incident light to achieve the desired focusing effect at single focus.

As shown in FIG. 4, parameter η₁ is defined (step 210), assuming a binary amplitude grating having a square wave profile with a period of 2λf when expressed as a function of r². The parameter η₁ represents the energy of the first diffraction order relative to the other diffraction orders. This ratio is crucial as it determines the strength of focus at a single point. In the context of the “hybrid” light focusing pattern, maximizing this ratio provides that a significant portion of the incident light is concentrated at the desired focal point, enhancing the focusing contrast. Thus, parameter η₁ is defined by Fourier coefficients, Aₙ, of the periodic square wave transmission profile t(r²) as:

$${η}_{1} = {A}_{1}^{2} / {\sum }_{n = 0}^{N} {A}_{n}^{2} \qquad ( 7 )$$

where Aₙ are the Fourier coefficients of t(r²), and Aₙ² indicates the energy of fₙ=f/n (see Eq. (3) above).

In the specific, non-limiting example described below, it was assumed that N=8.

Then, parameter η₂ is defined (step 220). As noted above, parameter η₂ measures the energetic efficiency of the light focusing pattern and is indicative of how effectively the light focusing pattern utilizes the incident light to achieve the desired focusing effect at single focus (at focal length of f, which is the energy of the first Fourier coefficient A₁). Thus, parameter η₂ is defined by a first Fourier coefficient A₁ of the periodic square wave transmission profile t of the binary Fresnel Zones, where integration is performed over a single Dammann grating period:

$${η}_{2} = {A}_{1 / Area of a period}^{2} = {A}_{1}^{2} / {\int }_{0}^{1} t ( x ) d x \qquad ( 8 )$$

Here, x designates the radial axis.

Then, a combined parameter η is defined as η=η₁η₂ (step 230). By combining the two parameters, η₁ and η₂, in a product, η₁η₂, both the focusing effect and the energetic efficiency of the pattern are taken into account.

In step 240, the parameter η is calculated for each set of chosen transition points, x₁, . . . , x_{M}.

In the exemplary optimization of the arrangement of the transition points presented herein, the process is aimed at optimizing the imaging properties of the light focusing pattern and a parameter sweep of the transition points is performed, designated as x₁, x₂ and x₃ (only 3 transition points per period of the Dammann were assumed). These parameters were constrained within the range 0 to 1, adhering to the inequality x₁<x₂<x₃. This constraint provides a methodical exploration of the parameter space, facilitating a thorough investigation of the behavior of the light focusing pattern (a so-called “hybrid grating”) under varied values of the transition points.

For each unique triplet of transition point values, the corresponding Fourier coefficients were determined. Following this, parameter η was calculated for each set of parameters.

In step 250, the optimization process is directed towards identifying the set of parameters that yields the maximal value of parameter η, ηₘₐₓ, which represents the optimal configuration for the hybrid grating. The process includes searching over all possible options within a given range of values imposed by the physical constraints of the problem.

This optimal set may be further refined by the condition that the difference between any two consecutive parameters exceeds 0.05. This constraint is imposed to avoid overpassing the maximum resolution during the fabrication process which includes printing the mask on a slide with a high-resolution printer.

FIG. 2 shows the characteristics and specifications of an exemplary CDFZP with the highest ability to focus 532 nm light at a focal length of 3 cm, obtained by using the above-described method.

The transition points for the “hybrid grating” described above affect/define the focusing efficiency. For the hybrid grating exemplified in FIG. 2 the transition points (positions are normalized to the size of the period) are x₁=0.05263, x₂=0.10526, x₃=0.52631.

The normalized Fourier coefficients of such hybrid grating with the highest score (i.e., maximal value of η, ηₘₐₓ) are presented in Table 1.

TABLE 1

| Name | A₀ | A₁ | A₂ | A₃ | A₄ | A₅ | A₆ | A₇ | A₈ |
|---|---|---|---|---|---|---|---|---|---|
| Value | 1 | 0.4009 | 0.0069 | 0.0144 | 0.0148 | 0.0036 | 0.0198 | 0.0109 | 0.0176 |

These coefficients are normalized relative to the A₀ coefficient (no focusing ability), facilitating an easier and more effective comparison of their relative magnitude. The efficiency of the CDFZP (hybrid grating) is quantified by the parameter η, calculated to be 37.28. The worst value of η that was obtained during the optimization process was 0.00403.

It should be noted that the values for parameter η are not the energetic efficiency in percentages but rather the product between the expressions of Eqs. (7) and (8).

Obviously the higher the value of parameter η is, the better its effect is (i.e., more energy in the first diffraction order and in the transmission of the grating in general).

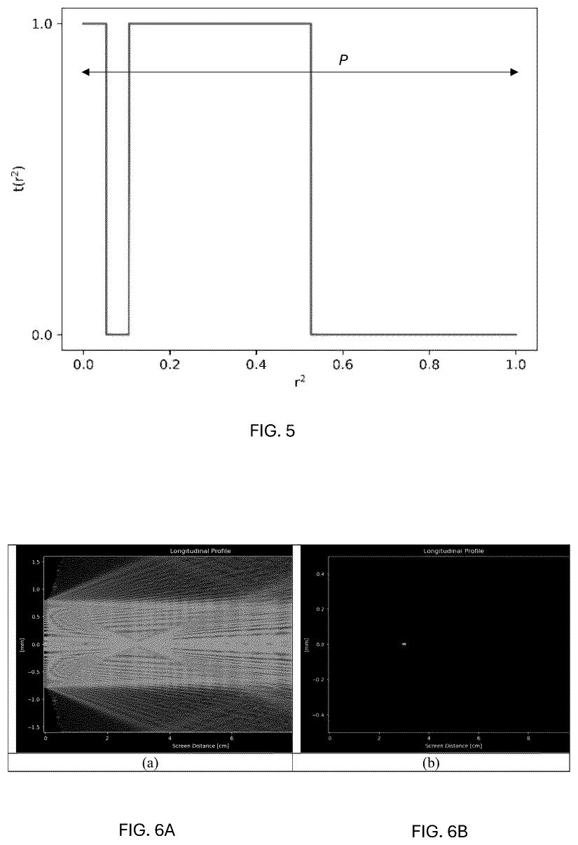

The optimization process conducted/simulated by the inventor has shown an improvement of about 4 orders of magnitude between the worst and the best values. The plot of a single period P of the optimized grating (optimized light focusing pattern) is exemplified in FIG. 5.

Next, thorough simulations were performed with the diffractsim Python library [R. De la Fuente, “Diffractsim: A flexible python diffraction simulator,” Zendo, 2022. DOI: 10.5281/zenodo.6843673] to emulate the propagation of 532 nm light through hybrid grating with the characteristics discussed above. This computational model allowed evaluation and validation of the optical behavior of the hybrid grating of the present disclosure. The results are shown in FIGS. 6A and 6B, which illustrate the focusing properties of the hybrid gratings, highlighting their performance.

FIG. 6A presents the electric field distribution as the plane wave emerges from the hybrid grating. The grating effectively modifies the phase of the incoming light, steering it towards a single main focal point (instead of multiple focal points like in the case of a regular Fresnel Zone plate). FIG. 6B complements this by displaying the intensity of the electric field, highlighting the focal point. Notably, the simulations confirm the optimization results: most of the incoming light is concentrated in a single point (namely A₁, i.e. the focal length of f) demonstrating a clear difference from the multifocal patterns typically associated with a conventional binary Fresnel zone plate. The single-point focus emphasizes the precision with which the hybrid grating of the present disclosure can direct light, thereby confirming its enhanced capabilities for imaging, optical fabrication, and others.

Moreover, the focal length, as determined from the peak intensity on the intensity profile, is measured as 3 cm. This is in accordance with the specified design parameters for the hybrid grating at the given wavelength of 532 nm. Thus, the performed simulations indicate that the hybrid grating with a diameter of 1.6 mm, configured/optimized according to the present disclosure, demonstrates a significant advantage in terms of focusing efficiency and accuracy, compared to other evaluated versions. These simulations demonstrate the advantages of the technique of the present disclosure in applications where precise light manipulation is crucial, such as in optical imaging systems and photonics devices.

Further simulations were performed with the diffractsim [R. De la Fuente, “Diffractsim: A flexible python diffraction simulator,” Zendo, 2022. DOI: 10.5281/zenodo.6843673] Python library to evaluate the imaging properties of the CDFZP/hybrid grating of the present disclosure in comparison to a traditional lens. These simulations were aimed at analyzing the ability of the CDFZP to manipulate light in an energy-efficient manner, as well as assessing its potential to enhance the imaging quality in terms of resolution and contrast.

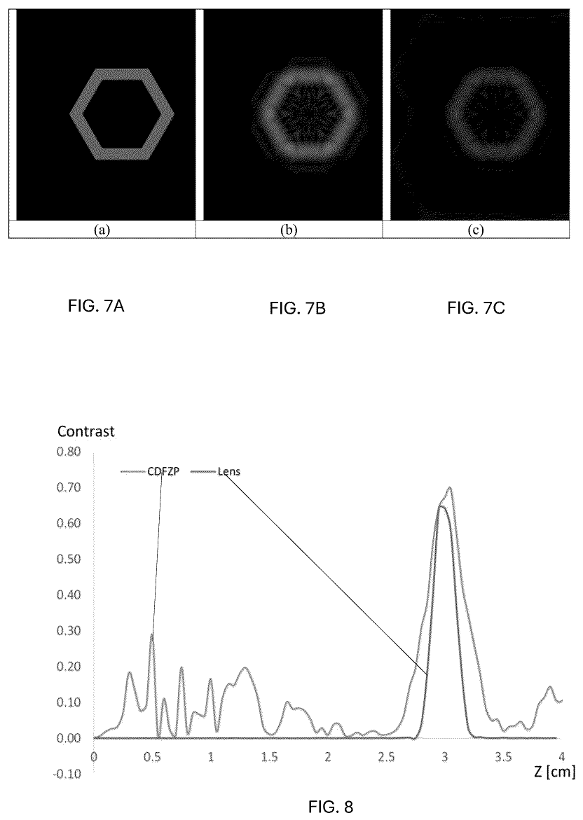

Test images are shown in FIGS. 7A to 7C, illustrating simulation for two basic optical imaging systems. One is equipped with the CDFZP as its imaging lens and the other one with a traditional refractive lens. By employing a reference image (FIG. 7A) as ground-truth, the imaging quality was evaluated being obtained by both optical imaging systems.

FIG. 7B illustrates the imaging result through a conventional lens. As expected, the conventional lens displays a predictable diffraction pattern with standard resolution and contrast profile.

In contrast, FIG. 7C presents the image captured through the CDFZP of the present disclosure. The unique structure of the CDFZP results in a more uniform intensity distribution across the image, but lower contrast. The presence of the 0^{th} diffraction order (A₀ Fourier coefficient, which represents no focusing), inherent to the CDFZP configuration, contributes to a baseline intensity that reduces the overall contrast in the image.

Comparing the two results, one can observe that the resolution of the image obtained via the CDFZP of the present disclosure is generally similar to the conventional lens, as in both cases the highest spatial frequency (the smallest discernible spatial feature) are identical. It should be noted that the simulations corroborated the energy efficiency of the CDFZP, intrinsic to their design. By directing more photons into the 1^{st} diffraction order (A₁ Fourier coefficient), the CDFZP maximizes the energy utilized for imaging, making it a potentially valuable component in systems where energy efficiency is paramount.

The optical performance of imaging systems can be evaluated using the through focus modulation transfer function (MTF) [Z. Zalevsky, Amir Shemer, Alexander Zlotnik, et al., “All-optical axial super resolving imaging using low-frequency binary-phase mask,” Opt. Express 14(7), 2631 (2006)]. It provides a quantitative measure of the system's ability to reproduce contrast from the object to the image as a function of spatial frequency. In the present disclosure, the through focus MTF curves were determined for two distinct optical components: a conventional lens and the CDFZP (FIG. 8).

In the following, the focusing capabilities of the CDFZP of the present disclosure are evaluated, by employing an experimental optical setup in which a collimated 532 nm laser beam was directed/focused through the CDFZP. The setup included only a single imaging element as described in the numerical simulation presented above. The element was printed on a slide and had 20 periods. The imaging element was either CDFZP or a traditional refractive imaging lens. The beam profile was reconstructed based on a series of images captured at 1 mm intervals along the z-axis, providing insight into the propagation characteristics of the laser beam through air.

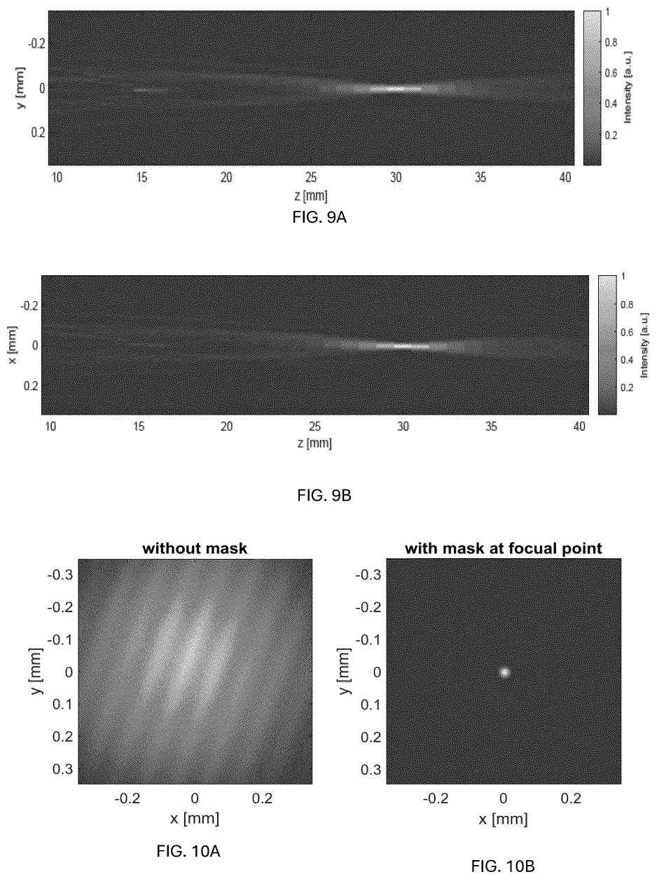

FIGS. 9A and 9B illustrate the beam propagation profile along the z-axis, offering a clear view of the beam's trajectory in free space.

FIGS. 10A and 10B present a comparative analysis of the laser beam profile with the CDFZP in place (FIG. 10B) and without the CDFZP in place (FIG. 10A). FIG. 10A shows the unfocused beam's broad and diffused profile. In stark contrast, the image shown in FIG. 10B, acquired with the CDFZP in place, reveals a focused beam, demonstrating the effectiveness of the CDFZP in beam shaping and focusing.

It should be noted that in the defocused beam of the ‘without mask’ configuration, shown in FIG. 10A, interference fringes are generated inside the spot beam due to the glass plate being positioned on top of the detection array (in the camera) and since the illumination beam was a coherent laser beam.

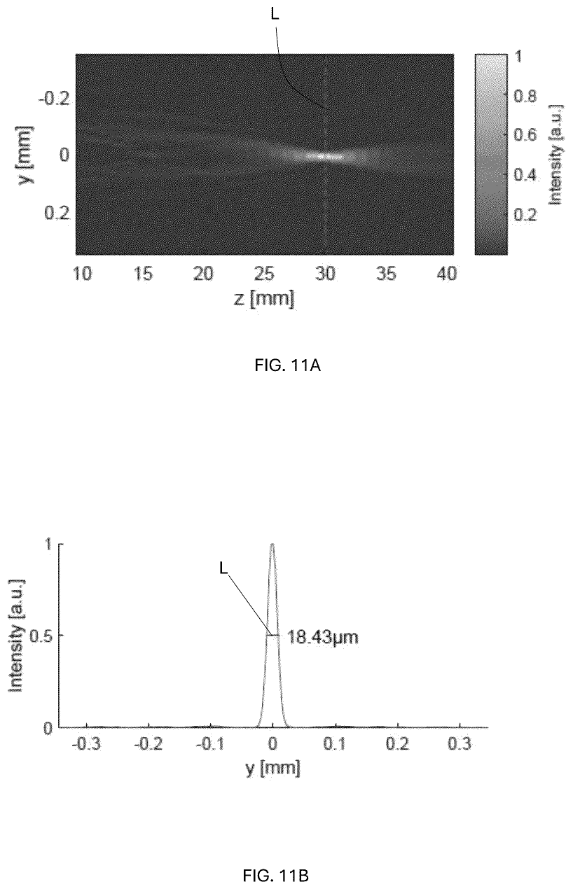

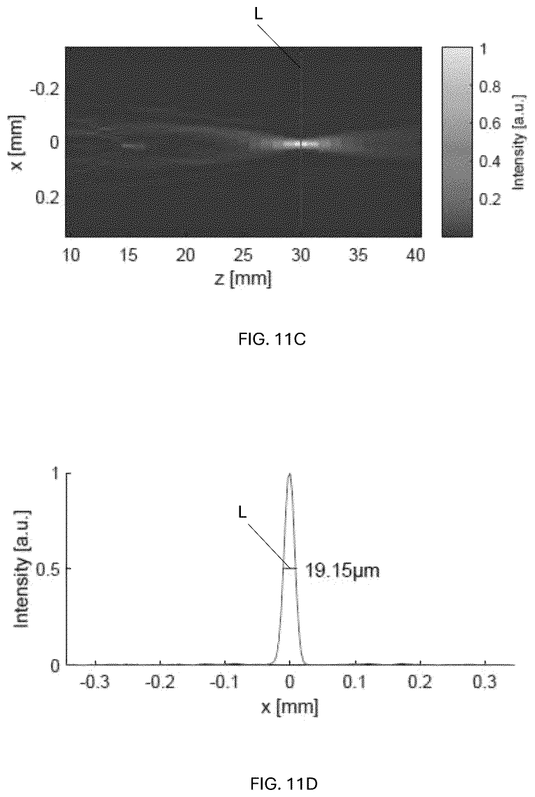

FIGS. 11A and 11C provide a detailed examination of the beam's focal spot, indicated by a dashed line L. FIGS. 11B and 11D illustrate the intensity profile with the line L denoting the full width at half maximum (FWHM) of the spot. The FWHM values of 18.43 μm and 19.15 μm along the y and x axes, respectively, quantify the focusing precision of the CDFZP. Those numbers are very close to the theoretical resolution limit of λF_{#} where λ is the optical wavelength (532 nm) and F_{#} is the F-number of the imaging element (that in the case described herein was about 19 since the illumination spot diameter was about 1.6 mm and the focal length was 3 cm). These experiments confirm the simulation predictions for the ability of the CDFZP to concentrate a laser beam to a focal spot.

As described above, the CDFZP of the present disclosure can be configured to provide an extended depth of focus (EDOF) around a focal plane of an optical element having a predetermined focal length f. Specifically, the CDFZP is created on a region of a surface of the optical element, such that the created pattern of the CSFZP provides an extended depth of focus around the focal plane of the optical element. The optical element may be any one of the following: a lens, an ophthalmic lens, a contact lens, a lens unit formed by a surface of cornea and eye lens.

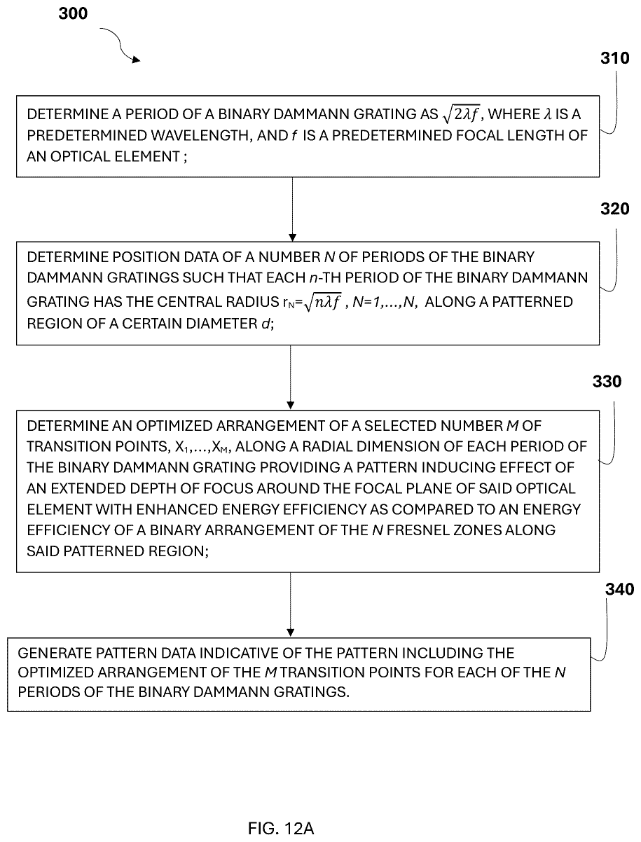

Reference is made to FIG. 12A showing a flow diagram 300 of a method to create a pattern on a surface of an optical element within a surface region of a certain diameter. The pattern is configured for providing an extended depth of focus around a focal plane f of the optical element.

In step 310 a period of a binary Dammann grating is determined as \sqrt{2λf}, where λ is a predetermined wavelength, and f is the predetermined focal length of the optical element.

In the non-limiting example described further below, the focal length of an eye is used.

In step 320 position data for each period of the number N of periods of the binary Dammann gratings is determined such that each n-th period of the binary Dammann grating has the central radius rₙ=\sqrt{nλf}, n=1, . . . , n, along a patterned region of a certain diameter d. In the example of a human eye, the certain diameter d may be defined by the entrance pupil diameter (EPD) of the eye.

In step 330 an optimized arrangement of a selected number M of transition points, x₁, . . . , xₘ, along a radial dimension of each period of the binary Dammann grating is determined. The optimized arrangement is aimed at providing an extended depth of focus around the focal plane of the optical element with enhanced energy efficiency (as compared to an energy efficiency of a binary arrangement of the N Fresnel zones along the patterned region).

The optimization criteria is as follows:

$${η}_{EDOF} = Δ z \cdot {\int }_{0}^{1} t ( x ) dx \qquad ( 9 )$$

where Δz is the axial range for which the through focus MTF is above normalized value of 0.2 or another predefined threshold of optimization, and

$${\int }_{0}^{1} t ( x ) dx$$

is the energy passing through the binary Dammann mask ([0,1] is the period of the Dammann based mask, while x is the radial axis of the mask). It should be noted that here, as in the Eq. 8 above, x designates the radial axis.

The criteria for the optimal transition points are set to extend the focus around the focal spot of the lens of the eye.

Finally, in step 340, pattern data is generated, indicative of the pattern including the optimized arrangement of the M transition points for each of the N periods of the binary Dammann gratings.

In the following, the creation (by simulation) of a pattern is exemplified aimed at providing an extended depth of focus with respect to the focal length of the lens of a human eye, e.g., by designing a Dammann grating structure on the cornea of an eye.

FIG. 12B shows an exemplary simulation of a CDFZP realized on a surface of a human eye model with an entrance pupil diameter (EPD) of 3.5 mm. Four periods of Dammann gratings were calculated with the following coordinates (rₘᵢₙ, rₘₐₓ) [mm]: (0.126,0.257), (0.78,1.19), (1.22,1.32), (1.4,1.58). In this non-limiting example, the pattern data is simulated for the central wavelength of green light (532 nm).

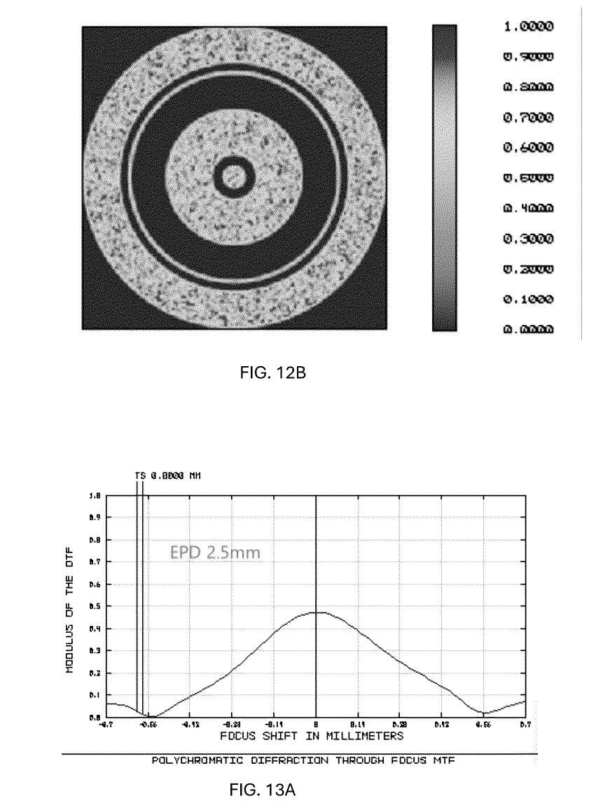

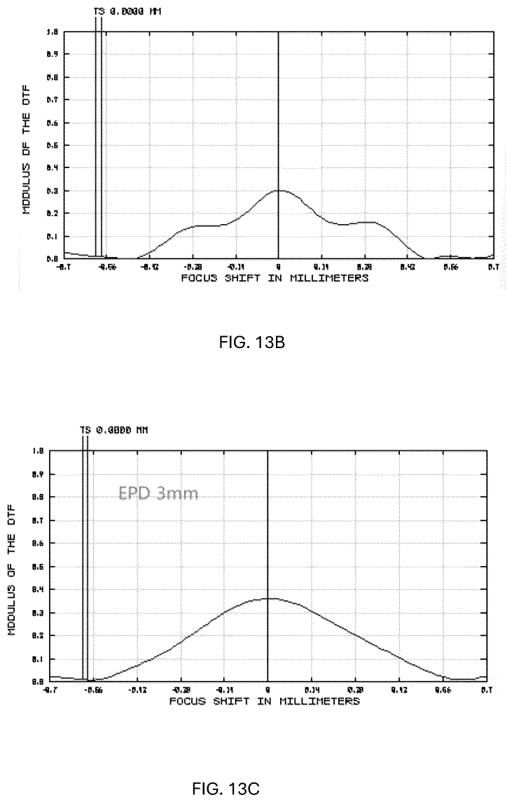

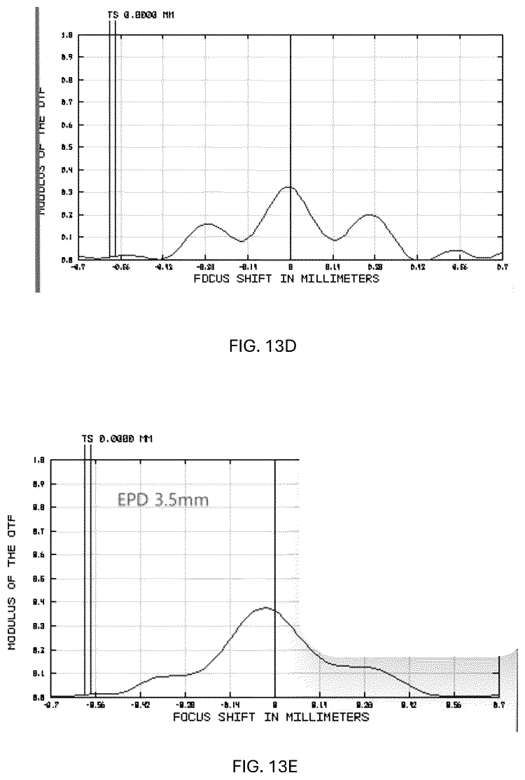

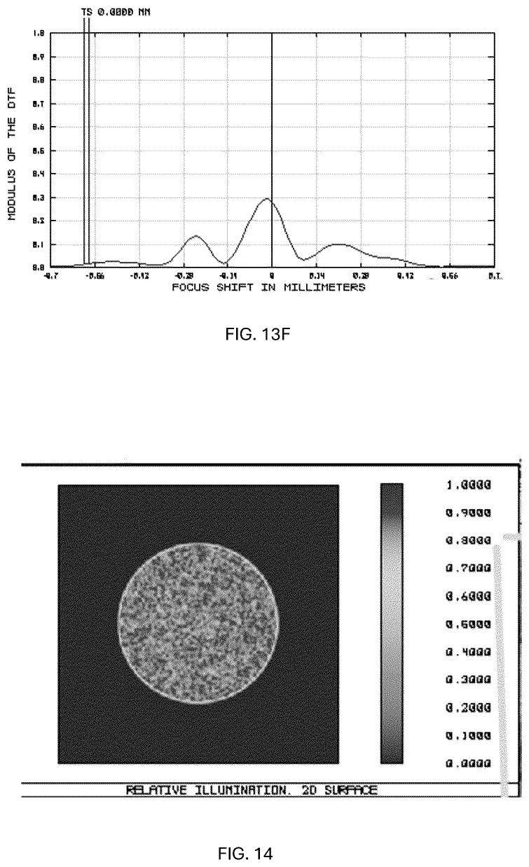

FIGS. 13A to 13F show the calculated modulus of the Optical Transfer Function (OTF) known as the Modulation Transfer Function (MTF), describing how an optical system transfers spatial frequency content from the object to the image. Specifically, the MTF represents the contrast of different spatial frequencies. The curves show the MTF plotted as a function of focus shift (defocus), thus providing insights into the depth of focus, aberrations, and overall performance of the imaging system. The MTF performance is shown for different spatial frequencies and different entrance pupil diameters (EPDs).

FIGS. 13A and 13B show MTF performance for EPD of 2.5 mm at 50 cycles/mm (FIG. 13A) and 100 cycles/mm (FIG. 13B), FIGS. 13C and 13D show MTF performance for EPD of 3 mm at 50 cycles/mm (FIG. 13C) and 100 cycles/mm (FIG. 13D), and

FIGS. 13E and 13F show MTF performance for EPD of 3.5 mm at 50 cycles/mm (FIG. 13E) and 100 cycles/mm (FIG. 13F).

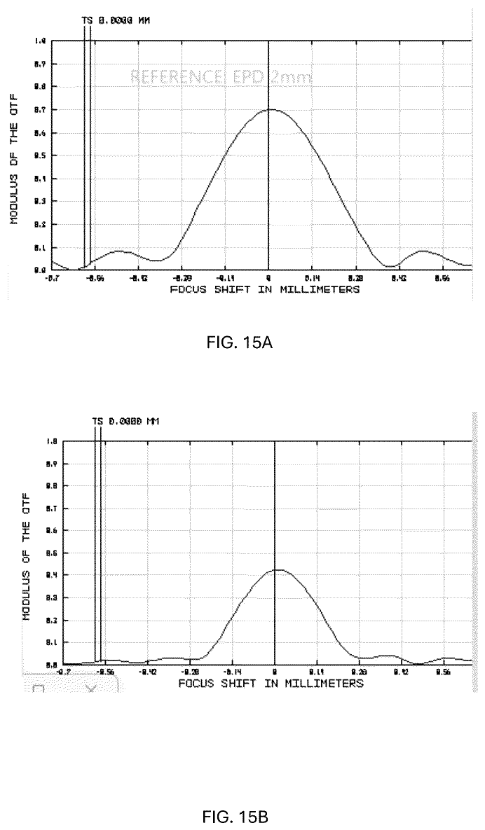

FIG. 14 shows a homogenously illuminated reference human eye model with EPD of 2 mm. FIGS. 15A and 15B show, respectively, the MTF performance at 50 cycles/mm and 100 cycles/mm.

It can be seen that the use of the CDFZP of the present disclosure, even at EPD of 3 mm, provides as broad MTF curve vs. focus shift as the reference lens (human eye model of FIG. 12B) at 2 mm, indicating that the CDFZP maintains contrast over a large defocus range. As expected, at high spatial frequencies (corresponding to fine details) the MTF performance degrades more quickly than at low frequencies.

Thus, the technique of the present disclosure provides the novel approach for designing configuring a light focusing pattern to be provided in a region of a surface, and the light focusing pattern of the present disclosure (CDFZP/hybrid grating) can advantageously be used in various applications.

The novel binary Dammann gratings arrangement optimized based on transmission property of binary Fresnel zone plates and optimized Fresnel zone geometry, unlike conventional approaches that distribute light non-uniformly across multiple points, provides for concentrating most of the incident light into a tunable, small number of focusing points, that are intensely equalized or provide extension of depth of focus around existing focal point. This novel approach significantly enhances the efficiency and precision of light manipulation, rendering the proposed optical element as a highly valuable tool in fields where precise light control is paramount.

A practical example of an important application in which the technique of the present disclosure is very useful relates to ophthalmic applications. For example, such optical application may utilize ablation of the cornea epithelium for removing the need in glasses. Such ophthalmic techniques are described for example in the following patent publications: U.S. Ser. No. 12/171,692 and WO24201468, which are incorporated herein by reference. Only a binary amplitude ablation is possible in that application, and thus the pattern of the present disclosure is suitable for that application since energetic efficiency and amount of energy diverted towards A₁ may be as high as possible according to the technique of the present disclosure.

It should also be noted that artificial intelligence (AI) and machine learning algorithms can be used to forecast CDFZP configurations that are optimal for specific applications including those for inducing single-focus property and/or extended depth of focus around the given focal plane. For instance, a specific cost function related to certain features in the image quality could be defined dependent on the specific application and the AI algorithm is used to optimize the zone plate structure to minimize the defined cost function. In addition, in some applications where binary non real structure could be feasible for realization or in applications where the structure could even be non-binary, the AI algorithms could take the new constrains over the structure into account when performing the optimization process.

1. A method for use in producing a pattern on a surface of an element within a surface region of a certain diameter to create a patterned region with predetermined focusing property, the method comprising:
utilizing transmission property of a binary arrangement of N Fresnel Zones along the patterned region of the certain diameter for a predetermined wavelength λ and a predetermined focal length f, where each n-th Fresnel zone has a central radius rₙ=\sqrt{nλf}, n=1, . . . , N, and determining a period P of a binary Dammann grating as \sqrt{2λf} and position data of the number N of periods of the binary Dammann gratings such that each n-th period of the binary Dammann grating has the central radius rₙ=\sqrt{nλf};
utilizing data indicative of the period P of the binary Dammann grating and said position data and determining an optimized arrangement of a selected number M of transition points, x₁, . . . , x_{M}, along a radial dimension of each period of the binary Dammann grating such that the optimized arrangement of the transition points provides said predetermined focusing property of the pattern with enhanced energy efficiency as compared to an energy efficiency of the binary arrangement of the N Fresnel zones; and
generating pattern data indicative of the pattern comprising the optimized arrangement of the M transition points for each of said N periods of the binary Damman gratings.

2. The method according to claim 1, wherein said predetermined focusing property corresponds to the predetermined focal length f to be provided by the pattern created on said surface region.

3. The method according to claim 1, wherein said element is an optical element, said predetermined focal length f corresponds to a focal plane of the optical element, said predetermined focusing property characterizing an extended depth of focus around said focal plane being provided by the pattern created in said surface region.

4. The method according to claim 3, wherein the optical element being one of the following: a lens, an ophthalmic lens, a contact lens, a lens unit formed by a surface of cornea and eye lens.

5. The method according to claim 1, wherein said optimized arrangement of the selected number M of the transition points, x₁, . . . , x_{M}, is determined to satisfy a condition for a maximal value of parameter ηₘₐₓ defined as a product η₁η₂, where parameter η₁ represents energy of a first diffraction order relative to the other diffraction orders in light interacting with the binary Damman gratings having said optimized arrangement of the M transition points, and parameter η₂ represents energetic efficiency of the binary Damman gratings having said optimized arrangement of the M transition points and is indicative of how effectively it manipulates the light interacting with said binary Damman gratings to achieve said predetermined focusing property.

6. The method according to claim 5, wherein the parameter η₁ is defined by Fourier coefficients, Aₙ, of a periodic square wave transmission profile t(r²) as
$${A}_{1}^{2} / {\sum }_{n = 0}^{N} {A}_{n}^{2} ,$$
and the parameter η₂ is defined by a first Fourier coefficient A₁ of the periodic square wave transmission profile t of the binary Fresnel Zones as
$${A}_{1}^{2} / {\int }_{0}^{1} t ( x ) dx ,$$
where integration is performed over a single Dammann grating period P with x being a coordinate along a radial axis.

7. The method according to claim 5, wherein said determining of the optimized arrangement comprises iteratively performing the following:
for each set of coordinates of the M transition points, x₁, . . . , x_{M}, calculating corresponding values of the Fourier coefficients Aₙ, and calculating a value of the parameter η; and
identifying the set of the coordinates of the transition points that yields the maximal value of the parameter η.

8. The method according to claim 1, further comprising: utilizing said pattern data to operate a patterning system to create the pattern on the surface region of said surface.

9. The method according to claim 8, wherein said surface is a surface of an eye cornea associated with an eye lens having said predetermined focal length f, said focusing property of the pattern characterizing an extended depth of focus around a focal plane of the eye lens.

10. The method according to claim 8, wherein said surface is a surface of an optical element having said predetermined focal length f, said focusing property of the pattern characterizing an extended depth of focus around a focal plane of the optical element.

11. The method according to claim 10, wherein said optical element is a lens.

12. The method according to claim 10, wherein said optical element is a contact lens.

13. The method according to claim 10, wherein said optical element is an ophthalmic lens.

14. The method according to claim 9, wherein said pattern is configured for correcting refractive error of user's eye caused by myopia or presbyopia progression.

15. An optical element having a surface comprising a pattern within a patterned region of said surface, said pattern being characterized by a predetermined focusing property with respect to incident light of wavelength λ and with respect to a predetermined focal length f, the pattern being formed by a concentric circular arrangement of N periods of binary Damman Gratings, wherein a period P of the binary Dammann grating is defined \sqrt{2λf}, each n-th period of the binary Dammann gratings has a central radius rₙ=\sqrt{nλf}, and each binary Dammann grating comprises a selected arrangement of M transition points, said selected arrangement of M transition points being optimized such that said focusing property of the pattern provides one of the following: (i) inducing focusing functionality to the optical element providing said predetermined focal length f with enhanced energy efficiency as compared to an energy efficiency of an arrangement of N binary Fresnel zones each having said central radius rₙ=\sqrt{nλf} or (ii) provides an extended depth of focus with enhanced energy efficiency around a given focal plane of said optical element having said predetermined focal length f.

16. The optical element according to claim 15, being configured as a lens having said predetermined focal length f.

17. The optical element according to claim 15, being configured as a contact lens having said predetermined focal length f.

18. The optical element according to claim 15, being configured as an ophthalmic lens having said predetermined focal length f.

19. The optical element of claim 15, being manufactured by the following method:
providing pattern data indicative of said pattern; and
utilizing said pattern data to create the pattern on a region of said surface;
wherein said providing of the pattern data comprises:
utilizing transmission property of a binary arrangement of N Fresnel Zones along a region of a given diameter d for a predetermined wavelength λ and a predetermined focal length f, where each n-th Fresnel zone has a central radius rₙ=\sqrt{nλf}, n=1, . . . , N, and determining a period P of a binary Dammann grating as \sqrt{2λf} and position data of the number N of periods of the binary Dammann gratings such that each n-th period of the binary Dammann grating has the central radius rₙ=\sqrt{nλf};
utilizing data indicative of the period P of the binary Dammann grating and said position data and determining an optimized arrangement of a selected number M of transition points, x₁, . . . , x_{M}, along a radial dimension of each period of the binary Dammann grating such that the optimized arrangement of the transition points provides said predetermined focusing property of the pattern with enhanced energy efficiency as compared to an energy efficiency of the binary arrangement of the N Fresnel zones; and
generating said pattern data indicative of the pattern comprising the optimized arrangement of the M transition points for each of said N periods of the binary Damman gratings.

20. An imaging system comprising an optical element configured as the optical element according to claim 15.

21. A system for carrying out the method of claim 1.

22. A system for use in producing a pattern with a predetermined focusing property to be formed within a surface region of a certain diameter of an optical element, the system being configured as a computerized system comprising data input and output utilities, memory utility and a data processor system, the data processor system comprising:
an analyzer configured and operable to utilize transmission property of a binary arrangement of N Fresnel zones along said patterned region of the certain diameter for a predetermined wavelength λ and a predetermined focal length f, where each n-th Fresnel zone has a central radius rₙ=\sqrt{nλf}, n=1, . . . , N, and determining a period of a binary Dammann grating as \sqrt{2λf} and position data of the number N of periods of the binary Dammann gratings such that each n-th period of the binary Dammann grating has the central radius rₙ=\sqrt{nλf};
a Dammann grating optimizer configured and operable to utilize data indicative of the period of the binary Dammann grating and said position data and determine an optimized arrangement of a selected number M of transition points, x₁, . . . , x_{M}, along a radial dimension of each period of the binary Dammann grating such that said optimized arrangement of the transition points provides said predetermined focusing property of the pattern providing one of the following: (i) inducing focusing functionality in the optical element providing the focal length f of the pattern with enhanced energy efficiency as compared to an energy efficiency of the binary arrangement of the N Fresnel zones; or (ii) providing an extended depth of focus with enhanced energy efficiency around a focal plane of an optical element with said predetermined focal length f having said patterned region; and
a pattern data generator configured and operable to generate pattern data indicative of the pattern comprising the optimized arrangement of the M transition points for each of said N periods of the binary Damman gratings.

23. The system according to claim 22, wherein the Dammann grating optimizer is configured and operable to determine said optimized arrangement of the selected number M of the transition points, x₁, . . . , x_{M}, satisfying a condition for a maximal value of parameter ηₘₐₓ defined as a product η₁η₂, where parameter η₁ is defined by Fourier coefficients, Aₙ, of the periodic square wave transmission profile t(r²) as
$${A}_{1}^{2} / {\sum }_{n = 0}^{N} {A}_{n}^{2} ,$$
and parameter η₂ is defined by a first Fourier coefficient A₁ of the periodic square wave transmission profile transmission t of the binary Fresnel Zones as
$${A}_{1}^{2} / {\int }_{0}^{1} t ( x ) dx ,$$
where integration is performed over a single Dammann grating period.

24. The system according to claim 23 wherein the Dammann grating optimizer is configured and operable to determine said optimized arrangement of the selected number M of the transition points, x₁, . . . , x_{M}, by iteratively performing the following:
for each set of coordinates of the M transition points, x₁, . . . , x_{M}, calculating corresponding values of the Fourier coefficients Aₙ, and calculating a value of the parameter η; and
identifying the set of the coordinates of the transition points that yields the maximal value of the parameter η.

25. The system according to claim 22 wherein said surface is a surface of an eye cornea associated with an eye lens having said predetermined focal length f, said focusing property of the pattern characterizing an extended depth of focus around a focal plane of the eye lens.

26. The system according to claim 22, wherein said optical element is a lens.

27. The system according to claim 22, wherein said optical element is a contact lens.

28. The system according to claim 22, wherein said optical element is an ophthalmic lens.

29. The system according to claim 25, wherein said pattern is configured for at least one of astigmatism correctio and correction of refractive error of user's eye caused by myopia or presbyopia progression.
